(19) United States
(12) Patent Application Publication
(10) Pub. No.: US 2014/0216871 A1
(43) Pub. Date: Aug. 7, 2014

(54) DAMPER FOR RAILWAY VEHICLES

(71) Applicant: Kazuaki Shibahara, Kanagawa (JP)

(72) Inventor: Kazuaki Shibahara, Kanagawa (JP)

(73) Assignee: Hitachi Automotive Systems,Ltd., Ibaraki (JP)

(21) Appl. No.: 14/234,732

(22) PCT Filed: Jul. 26, 2012
(86) PCT No.: PCT/JP2012/068964

§ 371 Date: Apr. 8, 2014

(30) Foreign Application Priority Data
Jul. 28, 2011 (JP) 2011-165570

(51) Int. Cl. B61F 5/24; F16F 9/348; F16F 9/18; F16F 9/32

(52) U.S. Cl. CPC B61F 5/24; F16F 9/3292; F16F 9/348; F16F 9/185
USPC 188/313

(57) ABSTRACT

[Problem] Provided is a damper for railway vehicles that uses disk valves as damping valves while ensuring reliability and durability.

[Means for Solving] A piston 13 connected to a piston rod 14 is inserted into a cylinder 12 having a hydraulic oil sealed therein. Extension and compression passages 22 and 23 are provided with extension and compression damping valves 25 and 26 having disk valves, respectively, and a fail-safe passage 24 is provided with a poppet-type fail-safe valve 27, The flow paths of hydraulic oil are switched over from one to another by a fail-safe switching valve 28 and a fail-safe on-off valve 29. Normally, the fail-safe switching valve 28 and the fail-safe on-off valve 29 are energized, and damping force is generated by the extension and compression damping valves 25 and 26 having disk valves, which are excellent in responsiveness. The damping force is adjusted with a control electric current. When a failure occurs, the energization is slopped, and a predetermined damping force is generated by the fail-safe valve 27, which is excellent in robustness.

### TECHNICAL FIELD

The present invention relates to a damper for railway vehicles that is mounted to a suspension system of a railway vehicle or other vehicles.

### BACKGROUND ART

In a railway vehicle, for example, dampers comprising a suspension spring and a hydraulic shock absorber or the like are mounted between a wheel set and a truck and between the truck and a car body to damp vibrations in both the up-and-down and lateral directions of the car body. There is also known a vibration damping system provided with various sensors for detecting vehicle conditions during running, such as a damping force variable damper capable of adjusting damping force, speed sensors detecting accelerations acting on the car body in the up-and-down and right-and-left directions, and displacement sensors detecting displacements of the wheel set, the truck and the car body. The damping force of the damping force variable damper is controlled with a controller on the basis of the detection by the various sensors, thereby effectively damping vibrations.

Conventional dampers for railway vehicles use poppet valves, which are highly resistant to contamination and excellent in durability and reliability, as damping valves for generating damping force, as mentioned in Patent Literature 1, for example. On the other hand, hydraulic shock absorbers mounted to automotive suspension systems generally use, as damping valves, disk valves, which are lightweight, excellent in responsiveness and capable of readily setting damping force characteristics. Disk valves, however, are problematic as compared to poppet valves. That is, the disk used as a valving element is readily subject to damage such as breakage. Therefore, disk valves are inferior in durability and, in addition, low in resistance to contamination and hence inferior in reliability. For this reason, disk valves have not heretofore been employed as damping valves in dampers for railway vehicles, which particularly require durability and reliability.

### CITATION LIST

### Patent Literature

Patent Literature 1: Japanese Patent Application Publication. No. Hei 11-132277

### SUMMARY OF INVENTION

### Technical Problem

An object of the present invention is to provide a damper for railway vehicles that uses disk valves as damping valves while ensuring reliability and durability.

### Solution to Problem

To solve the above-described problem, the present invention provides a damper mounted to a railway vehicle, the damper comprising a cylinder having a hydraulic fluid sealed therein, a piston slidably Inserted in the cylinder, a piston rod coupled to the piston, a first and second passages through which the hydraulic fluid flows in response to the movement of the piston, a first damping force generating mechanism generating damping force by controlling the flow of hydraulic fluid through the first passage, a second damping force generating mechanism generating damping force by controlling the flow of hydraulic fluid through the second passage, and a switching device switching the flow path of hydraulic fluid between the first passage and the second passage in response to a control electric current such that, when energized, the switching device opens the first passage and closes the second passage, whereas, when not energized, the switching device closes the first passage and opens the second passage, wherein the first damping force generating mechanism includes a disk valve opening upon receiving the pressure of the hydraulic fluid, and the second damping force generating mechanism is of a poppet type.

### Advantageous Effects of Invention

According to the damper for railway vehicle of the present invention, it is possible to use disk valves as damping valves while ensuring reliability and durability.

### BRIEF DESCRIPTION OF DRAWINGS

FIG. 1 is an explanatory view schematically showing the structure of a vibration damping system of a railway vehicle to which a damper for railway vehicles according to the present invention is mounted.

FIG. 2 is a circuit diagram schematically showing the structure of a damping force variable damper according to a first embodiment of the present invention.

FIG. 3 is a circuit diagram of a damping force variable damper according to a second embodiment of the present invention.

FIG. 4 is a vertical sectional view schematically showing the structure of the damping force variable damper according to the second embodiment of the present invention.

FIG. 5 is a sectional view taken along the line A-A in FIG. 4, showing damping force generating mechanisms of the damping force variable damper shown in FIG. 4.

FIG. 6 is a vertical sectional view taken along the line B-B in FIG. 5, showing the damping force generating mechanisms.

FIG. 7 is a circuit diagram of a damping force variable damper according to a third embodiment of the present invention.

FIG. 8 is a circuit diagram schematically showing the structure of a damping force variable damper according to a fourth embodiment of the present invention.

### DESCRIPTION OF EMBODIMENTS

Embodiments of the present invention will be explained below in detail on the basis of the drawings.

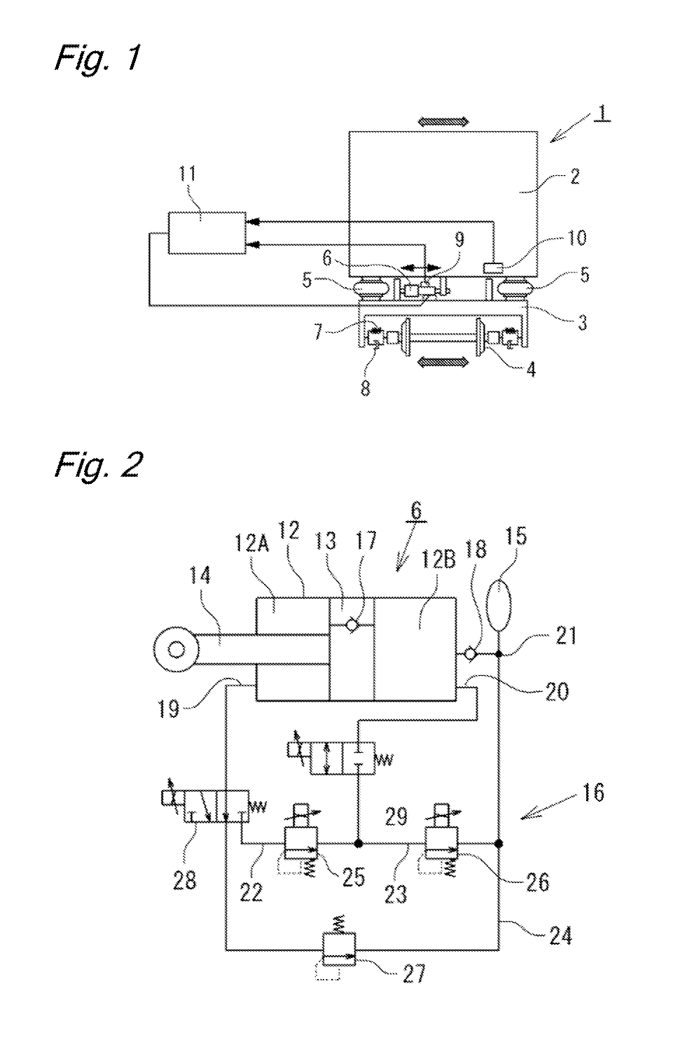

A first embodiment of the present invention will be explained with reference to FIGS. 1 and 2.

FIG. 1 schematically shows the structure of a railway vehicle equipped with a shock absorber according to this embodiment. As shown in FIG. 1, a railway vehicle 1 has a car body 2 having a wheel set 4 attached thereto through a truck 3. The truck 3 is coupled to the car body 2 so as to be rotatable about a vertical axis and displaceable to a predetermined extent in both an up-and-down direction and a right-and-left direction and supports the car body 2 with air springs 5. It should be noted that other spring devices, e.g. coil springs, may be used in place of the air springs 5. Between the car body 2 and the truck 3 is coupled a damping force variable damper 6 constituting a suspension system. The damping force variable damper 6 is a lateral damper (yaw damper) for railway vehicles. The damping force variable damper 6 strokes in response to a relative displacement between the car body 2 and the truck 3 in the right-and-left direction, thereby applying damping force. Between the truck 3 and the wheel set 4 are coupled suspension springs 7 and dampers 8 to absorb and damp vibrations between the truck 3 and the wheel set 4.

The damping force variable damper 6 is provided with a stroke sensor 9 detecting a relative displacement between the car body 2 and the truck 3 in the right-and-left direction. The car body 2 is provided with an acceleration sensor 10 detecting an acceleration acting on the car body 2 in the right-and-left direction. A controller 11 is provided to control the damping force of the damping force variable damper 6 on the basis of input signals from the stroke sensor 9 and the acceleration sensor 10. The controller 11 executes vibration control to suppress vibrations (roll) of the car body 2 in the right-and-left direction by properly adjusting the damping force of the damping force variable damper 6 on the basis of results of detection by the stroke sensor 9, the acceleration sensor 10, and other various sensors, such as a vehicle speed sensor, detecting a running condition of the vehicle, and also on the basis of running position information such as tunnel and rail cant information.

Next, the damping force variable damper 6 according to the first embodiment of the present invention will be explained with reference to FIG. 2. As shown in FIG. 2, the damping force variable damper 6 has a cylinder 12, a piston 13 slidably inserted in the cylinder 12, a piston rod 14 coupled to the piston 13 and extending to the outside of the cylinder 12, a reservoir 15 connected to the bottom of the cylinder 12, and a damping force generating mechanism 16 connected to the cylinder 12.

The interior of the cylinder 12 is divided by the piston 13 into two chambers, i.e. a cylinder chamber 12A closer to the piston rod 14, and a cylinder chamber 12B closer to the bottom of the cylinder 12. The piston 13 is provided with a check valve 17 allowing only the flow of hydraulic oil from the bottom-side cylinder chamber 12B toward the piston rod 14-side cylinder chamber 12A. Between, the cylinder chamber 12B and the reservoir 15 is provided a check valve 18 allowing only the flow of hydraulic oil from the reservoir 15 toward the cylinder chamber 12B. A hydraulic oil is sealed in the cylinder 12 as a hydraulic fluid, and he hydraulic oil and a gas, e.g. air, or nitrogen gas, are sealed in the reservoir 15. It should be noted that a relief valve may be provided in parallel to each of the check valves 17 and 18, which allows flow in the reverse direction when the pressure in the cylinder 12 becomes high.

The damping force generating mechanism 16 has three ports: a first port 19 connected to the cylinder chamber 12A; a second port 20 connected to the cylinder chamber 28; and a reservoir port 21 connected to the reservoir 15. Further, the damping force generating mechanism 16 is provided with an extension passage 22 connecting between the first port 19 and the second port 20, a compression passage 23 connecting between the second port 20 and the reservoir port 21, and a fail-safe passage 24 directly connecting between the first port 19 and the reservoir port 21, bypassing the extension and compression passages 22 and 23. The extension and compression passages 22 and 23 constitute a first passage through which the hydraulic oil flows in response to the movement of the piston 13, and the fail-safe passage 24 constitutes a second passage through which the hydraulic oil flows in response to the movement of the piston 13.

The extension passage 22 is provided with an extension damping valve 25 as a first damping force generating mechanism generating damping force by controlling the flow of hydraulic oil through the extension passage 22. The compression passage 23 is provided with a compression damping valve 26 as a first damping force generating mechanism generating damping force by controlling the flow of hydraulic oil through the compression passage 23. The extension and compression damping valves 25 and 26 each include a disk valve that deflects and lifts from the associated valve seat to open upon receiving the pressure of hydraulic oil, and that is capable of adjusting damping force according to an electric current supplied to the associated solenoid. The damping force adjusting mechanism is a pilot-type proportional solenoid valve that controls the valve opening of the disk valve by introducing the pressure of hydraulic oil into a pilot chamber provided at the back of the disk valve. It should be noted that the damping force adjustment of the extension and compression damping valves 25 and 26 is not limited to the type using the pilot pressure but may be of the type that adjusts the passage area, or the type that directly varies the spring load of the disk valve.

In addition, the fail-safe passage 24 is provided with a fail-safe valve 27 as a second damping force generating mechanism generating damping force by controlling the flow of hydraulic oil through the fail-safe passage 24. The fail-safe valve is a poppet-type pressure governor valve.

The first port 19 is provided with a fail-safe switching valve 28 as a switching device. The second port 20 is provided with a fail-safe on-off valve 29 as a switching device. The fail-safe switching valve 28 is a two-port two-position electromagnetic switching valve selectively connecting the first port 19 to either the extension passage 22 or the fail-safe passage 24. When not energized, the fail-safe switching valve 28 connects the first port 19 to the fail-safe passage 24 (position illustrated in the figure). When energized, the fail-safe switching valve 28 connects the first port 19 to the extension passage 22. The fail-safe on-off valve 29 is a normally-closed electromagnetic on-off valve. When not energised, the fail-safe on-off valve 29 cuts off the second port 20 and the compression passage 23 from each other (position illustrated in the figure). When energized, the fail-safe on-off valve 29 connects the second port 20 and the compression passage 23 to each other.

The following is an explanation of the operation of the damping force variable damper 6 structured as stated above.

Normally, in response to a control electric current from the controller 11, the fail-safe switching valve 28 is placed in an energized position to connect the first port 19 to the extension passage 22, and the fail-sale on-off valve 29 opens to connect the second port 20 and the compression passage 23 to each other.

In this state, during the extension stroke of the piston rod 14, the check valve 17 is closed by the sliding movement of the piston 13, and thus the hydraulic oil in the cylinder chamber 12A is pressurized to flow toward the cylinder chamber 12B through the first port 19, the extension passage 22 and the second port 20. Consequently, damping force is generated by the extension damping valve 25, and the damping force can be adjusted according to the control electric current. At this time, an amount of hydraulic oil corresponding to the amount by which the piston rod 14 withdraws from the cylinder 12 flows into the cylinder chamber 12B from the reservoir 15 by opening the check valve 18, and the gas in the reservoir 15 expands correspondingly, thereby making volumetric compensation.

During the compression stroke of the piston rod 14, as the piston 13 slidingly moves, the piston rod 14 enters the cylinder 12, and the check valve 17 opens, whereas the check valve 18 is closed. Consequently, both the cylinder chambers 12A and 12B are pressurized. At this time, because the check valve 17 is open, the cylinder chambers 12A and 12B are at the same pressure; therefore, there Is no flow of hydraulic oil between the first port 19 and the second port 20 (extension passage 22). Accordingly, the hydraulic oil in the cylinder chambers 12A and 12B flows through the compression passage 23 from the second port 20 and flows into the reservoir 15 from the reservoir port 21. Thus, damping force is generated by the compression damping valve 26, and the damping force can be adjusted according to the control electric current. At this time, the gas in the reservoir 15 is compressed, thereby making volumetric compensation.

If there should be a failure such as abnormality in the control system, the supply of electric current to the fail-safe switching valve 28 and the fail-sale on-off valve 29 is cut off. Consequently, the fail-sate switching valve 28 cuts off the first port 19 from the extension passage 22 and connects the first port 19 to the fail-safe passage 24. The fail-safe on-off valve 29 cuts off the connection between the second port 20 and the compression passage 23. Thus, the first port 19 is connected to the reservoir port 21 through the fail-safe passage 24.

In this state, during the extension stroke of the piston rod 14, the hydraulic oil in the cylinder chamber 12A is pressurized to flow through the fail-safe passage 24 from the first port 19 and to flow into the reservoir 15 from the third port 21. During the compression stroke of the piston rod 14, the hydraulic oil pressurized in the cylinder chambers 12A and 12B by the entry of the piston rod 14 flows through the fail-safe passage 24 from the first port 19 and flows into the reservoir 15 from the third port 21, in the same way as during the extension stroke. Consequently, during both the extension and compression strokes of the piston rod 14, a predetermined damping force is generated by the fail-safe valve 27.

Thus, normally, the extension and compression damping forces can be adjusted according to the control electric current from the controller 11 by the extension and compression damping valves 25 and 26, respectively, using disk valves, which are lightweight, excellent in responsiveness and capable of readily setting damping force characteristics. If a failure should occur, stable damping force can be generated by the fail-safe valve 27 comprising a poppet valve, which is highly resistant to contamination and highly robust. Therefore, reliability and durability can be ensured.

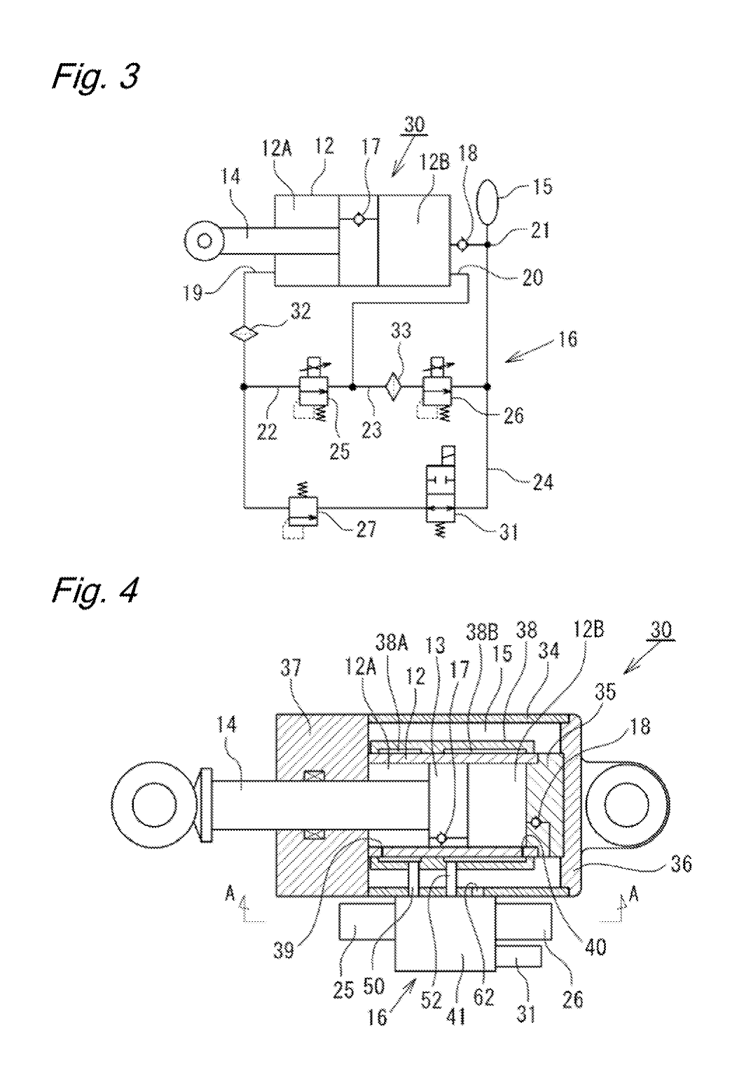

Next, a damping force variable damper according to a second embodiment of the present invention will be explained with reference to FIGS. 3 to 6. It should be noted that, in the following explanation, portions similar to those In the above-described first embodiment are denoted by the same reference marks as in the first embodiment, and that only the portions in which the second embodiment differs from the first embodiment will be explained in detail.

As shown in FIG. 3, a damping force variable damper 30 according to this embodiment omits the fail-safe switching valve 28 and the fail-safe on-off valve 29 serving as switching devices, which are shown in the first embodiment. The first port 19 is always connected to the extension passage 22 and the fail-safe passage 24, and the second port 20 is always connected to the extension and compression passages 22 and 23. The extension, and compression damping valves 25 and 26 are configured to generate damping force of “hard” damping characteristics when not energized. That is, the extension and compression damping valves 25 and 26 function as the switching devices in the foregoing first embodiment by generating damping force of “hard” damping characteristics when not energized. The fail-safe passage 24 is provided with a fail-safe on-off valve 31, which is a normally-open electromagnetic on-off valve. The first port 19 and the second port 20 are provided with filters 32 and 33, respectively, to enhance the resistance to contamination.

Next, a more specific structure of the damping force variable damper 30 of this embodiment will be explained with reference to FIGS. 4 to 6.

As shown in FIG. 4, the damping force variable damper 30 has a circular cylindrical outer tube 34 concentrically disposed around the outer periphery of the cylinder 12, and an annular reservoir 15 is formed between the cylinder 12 and the outer tube 34. The cylinder 12 has a base valve 35 attached to one end thereof as a closing member. The outer tube 34 has an end plate 36 attached to one end thereof as a closing member closing the one end of the outer tube 34. The base valve 35 is fitted to the end plate 36, and thus the one end of the cylinder 12 is secured to the outer tube 34. The cylinder 12 has a rod guide 3 attached to the other end thereof as a closing member closing the other end of the cylinder 12. The rod guide 37 is joined to the other end of the outer tube 34, and thus the other end of the cylinder 12 is secured to the outer tube 34. The piston rod 14 extends through the rod guide 37 slidably and liquid-tightly and projects to the outside. The check valve 18 is provided in the base valve 35.

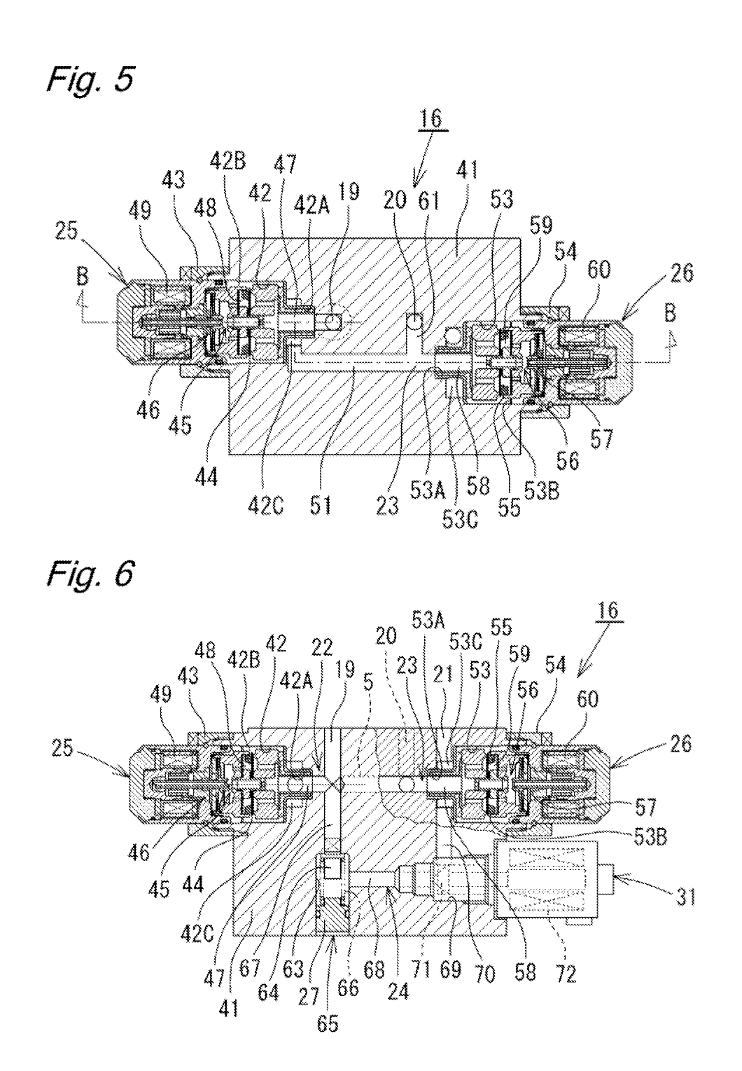

In the reservoir 15, a circular cylindrical passage member 38 is fitted around the outer periphery of the cylinder 12. The passage member 38 has two annular recesses 38A and 38B formed on the inner periphery thereof. The annular recesses 38A and 38B are connected to the cylinder chambers 12A and 12B through oil passages 39 and 40, respectively, extending through the side wall of the cylinder 12 near the opposite ends thereof. The damping force generating mechanism 16 is attached to the side wall of the outer tube 34. As shown in FIGS. 5 and 6, the damping force generating mechanism 16 has a structure in which the extension and compression damping valves 25 and 26, the fail-safe valve 27 and the fail-safe on-off valve 31 are installed through a valve block 41 attached to the side wall of the outer tube 34.

The extension damping valve 25 is inserted into a valve bore 42 formed in the valve block 41 and secured with a nut 43. The extension damping valve 25 comprises a main valve 44, a pilot valve 45, and a fail-safe valve 46, which are provided in the valve bore 42. The main valve 44 is a pilot-type (back-pressure type) disk valve. The pilot valve 45 is a solenoid-driven pressure control valve controlling the valve-opening pressure of the main valve 44. The fail-safe valve 46 is provided downstream of the pilot valve 45 to operate when there is a failure. Further, an inlet tube 47 is liquid-tightly inserted in a small-diameter portion 42A at the distal end of the valve bore 42. Hydraulic oil is introduced into the inlet tube 47 from the small-diameter portion 42A. The introduced hydraulic oil flows through the main valve 44, the pilot valve 45 and the fail-safe valve 46 and flows into a chamber 42B surrounded by the valve bore 42. The hydraulic oil in the chamber 42B flows into an intermediate-diameter portion 42C of the valve bore 42 formed adjacent to the small-diameter portion 42A.

In this regard, before the main valve 44 opens, the pilot valve 45 generates damping force by controlling the flow of hydraulic oil. When the main valve 44 is open, damping force is generated mainly by the main valve 44. In addition, hydraulic oil is introduced into a back-pressure chamber 48 (pilot chamber) at the back of the main valve 44 from the upstream side of the pilot valve 45, and the pressure in the back-pressure chamber 48 is applied to the main valve 44 in the valve-closing direction, thereby controlling the valve opening of the main valve 44. The damping force is adjusted by adjusting the control pressure of the pilot valve 45 with an electric current supplied to a solenoid 49, and the valve opening of the main valve 44 is adjusted with the pressure in the back-pressure chamber 48. Further, when a failure occurs, the supply of electric current to the solenoid 49 is cut off, thereby closing the fail-sale valve 46 to fix the damping force to the “hard” damping force characteristic side.

The small-diameter portion 42A of the valve bore 42, in which the extension damping valve 25 is installed, is communicated with the first port 19, and the first port 19 is connected to the annular recess 38A through a pipe line 50 (see FIG. 4) extending through the respective side walls of the outer tube 34 and the passage member 38. The intermediate-diameter portion 42C of the valve bore 42 is communicated with the second port 20 through a passage 51, and the second port 20 is connected to the annular recess 38B through a pipe line 52 (see FIG. 4) extending through the respective side walls of the outer tube 34 and the passage member 38.

The compression damping valve 26 has substantially the same structure as that of the above-described extension damping valve 25. The compression damping valve 26 Is inserted into a valve bore 53 formed in the valve block 41 and secured with a nut 54. The compression damping valve 26 comprises a main valve 55, a pilot valve 56, and a fail-safe valve 57, which are provided in the valve bore 53. The main valve 55 is a pilot-type (back-pressure type) disk valve. The pilot valve 56 is a solenoid-driven pressure control valve controlling the valve-opening pressure of the main valve 55. The fail-safe valve 57 is provided downstream of the pilot valve 56 to operate when there is a failure. Further, an inlet lube 58 is liquid-tightly inserted in a small-diameter portion 53A at the distal end of the valve bore 53. Hydraulic oil is introduced into the inlet tube 58 from the small-diameter portion 42A. The introduced hydraulic oil flows through the main valve 55, the pilot valve 56 and the fail-safe valve 57 and flows into a chamber 538 surrounded by the valve bore 53. The hydraulic oil in the chamber 53B flows into an intermediate-diameter portion 53C of the valve bore 53 formed adjacent to the small-diameter portion 53A.

In this regard, before the main valve 55 opens, the pilot valve 56 generates damping force by controlling the flow of hydraulic oil. When the main valve 55 is open, damping force is generated mainly by the main valve 55. In addition, hydraulic oil is introduced into a back-pressure chamber 59 (pilot chamber) at the back of the main valve 55 from the upstream side of the pilot valve 56, and the pressure in the back-pressure chamber 59 is applied to the main valve 55 in the valve-closing direction, thereby controlling the valve opening of the main valve 55. The damping force is adjusted by adjusting the control pressure of the pilot valve 56 with an electric current supplied to a solenoid 60, and the valve opening of the main valve 55 is adjusted with the pressure in the back-pressure chamber 59. Further, when a failure occurs, the supply of electric current to the solenoid 60 is cut off, thereby closing the fail-sale valve 57 to fix the damping force to the “hard” damping force characteristic side.

The small-diameter portion 53A of the valve bore 53, in which the compression damping valve 26 is installed, is communicated with the second port 20 through a passage 21. The intermediate-diameter portion 53C of the valve bore 53 is communicated with the reservoir port 21, and the reservoir port 21 is connected to the reservoir 15 through a passage 62 (see FIG. 4) extending through the side wall of the outer tube 34.

The fail-safe valve 27 has the following structure. A valving element 64 is inserted into a valve bore 63 formed in the valve block 41. The opening of the valve bore 63 is closed with a plug 65, and a valve spring 66 is interposed between the valving element 64 and the plug 65. The valve spring 66 is a compression coil spring. A passage 67 communicating with the first port 19 opens on the bottom of the valve bore 64, and a passage 68 opens on a side of the valve bore 63. The fail-safe valve 27 is a poppet-type pressure governor valve, which closes when the valving element 64 urged by the spring force of the valve spring 66 rests on an annular seat portion formed at the bottom of the valve bore 64 to close the flow path between the passages 67 and 68. The fail-safe valve 27 opens when the valving element 64 opens the flow path against the spring force of the valve spring 66 by receiving the pressure in the passage 67.

The fail-safe on-off valve 31 is a poppet-type normally-open electromagnetic on-off valve installed in a valve bore 69 formed in the valve block 41. With the fail-safe on-off valve 31, when a solenoid 72 is not energized, a valving element 71 opens a flow path between the passage 68, which opens on the bottom of the valve bore 69, and a passage 70 opening on a side of the valve bore 69. When the solenoid 72 is energized, the valving element 71 closes the flow path. The passage 70 is communicated with the reservoir port 21 through the intermediate-diameter portion 53C of the valve bore 53 for the compression damping valve 26.

With the above-described structure, normally, the fail-safe on-off valve 31 is closed to cut off the fail-safe passage 24 in response to the control electric current from the controller 11. In this state, during the extension stroke of the piston rod 14, the hydraulic oil in the cylinder chamber 12A is pressurized to flow toward the cylinder chamber 12B through the first port 19, the extension passage 22 and the second port 20, in the same way as in the above-described first embodiment. Thus, damping force is generated by the extension damping valve 25 comprising a disk valve, and the damping force can be adjusted according to the control electric current.

During the compression stroke of the piston rod 14, there is no flow of hydraulic oil between the first port 19 and the second port 20 (extension passage 22). The hydraulic oil in the cylinder chambers 12A and 12B flows through the compression passage 23 from the second port 20 and flows into the reservoir 15 from the reservoir port 21. Consequently, damping force is generated by the compression damping valve 26 comprising a disk valve, and the damping force can be adjusted according to the control electric current.

When, a failure occurs, the supply of electric current to the fail-sate on-off valve 31 and the extension and compression damping valves 25 and 26 is cut off. Consequently, the fail-safe on-off valve 31 opens to open the flow path of the fail-safe passage 24, and the extension and compression damping valves 25 and 26 are switched to the “hard” damping force characteristic side to narrow or close the flow paths of the extension and compression passages 22 and 23. In this state, during both the extension and compression strokes of the piston rod 14, the hydraulic oil flows mainly through the fail-safe passage 24, and a predetermined damping force is generated by the fail-safe valve 27.

Thus, it is possible to offer operational advantages similar to those of the above-described first embodiment while reducing the number of electromagnetic valves.

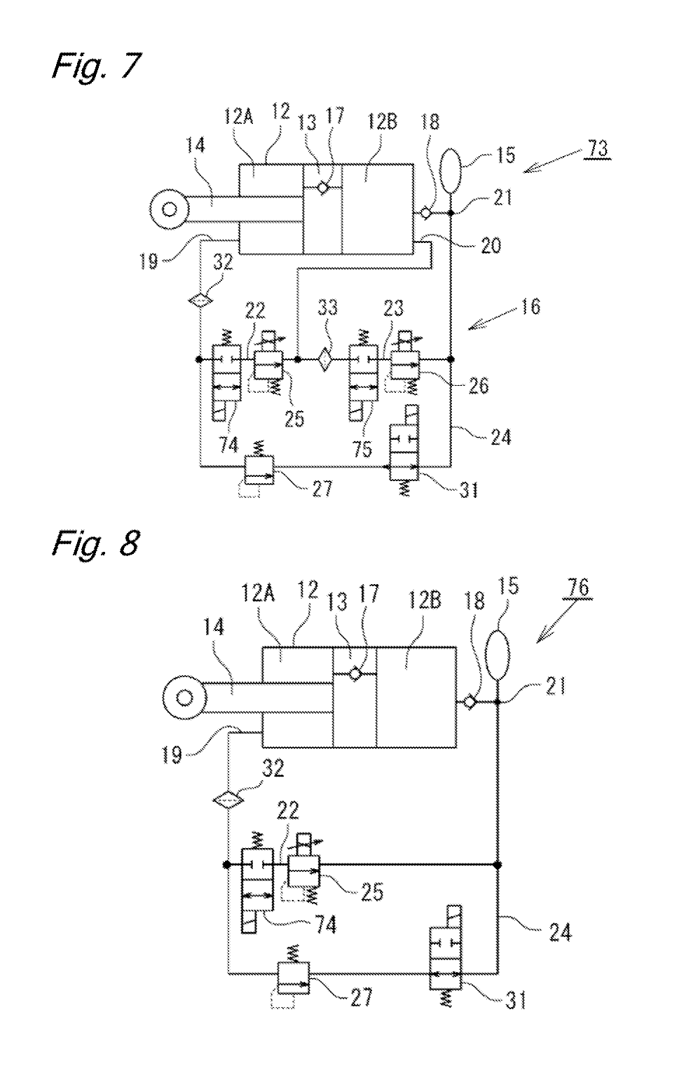

Next, a damping force variable damper according to a third embodiment of the present invention will be explained with reference to FIG. 7. It should be noted that, in the following explanation, portions similar to those in the above-described second embodiment are denoted by the same reference marks as in the second embodiment, and that only the portions in which the third embodiment differs from the second embodiment will be explained in detail.

In a damping force variable damper 73 according to this embodiment, the extension and compression damping valves 25 and 26 are configured to generate damping force of “soft” damping characteristics when not energized. In addition, the extension passage 22 has a fail-sate on-off valve 74 disposed therein in series to the extension damping valve 25. The fail-safe on-off valve 74 is a normally-closed electromagnetic on-off valve. Further, the compression passage 23 has a fail-safe on-off valve 75 disposed therein in series to the compression damping valve 26. The fail-safe on-off valve 75 is a normally-closed electromagnetic on-off valve.

With the above-described structure, normally, the fail-safe on-off valve 31 is closed to cut off the fail-safe passage 24, and the fail-safe on-off valves 74 and 75 are opened to open the extension and compression passages 22 and 23, in response to the control electric current from the controller 11. In this state, during the extension stroke of the piston rod 14, damping force is generated by the extension damping valve 25, and the damping force can be adjusted according to the control electric current, whereas, during the compression stroke, damping force is generated by the compression damping valve 26, and the damping force can be adjusted according to the control electric current, in the same way as in the above-described second embodiment.

When a failure occurs, the supply of electric current to the fail-safe on-off valves 31, 74 and 75 is cut off. Consequently, the fail-safe on-off valve 31 opens to open the flow path of the fail-safe passage 24, and the fail-safe on-off valves 74 and 75 are closed to cut off the flow paths of the extension and compression passages 22 and 23. In this state, during both the extension and compression strokes of the piston rod 14, the hydraulic oil flows through the fail-sale passage 24, and a predetermined damping force is generated by the fail-safe valve 27.

This embodiment requires a larger number of electromagnetic valves than in the above-described second embodiment but can offer operational advantages similar to those of the above-described first embodiment. In addition, the extension and compression damping valves 25 and 26 are configured to generate damping force of “soft” damping characteristics when not energized. Because these damping valves are generally used frequently on the “soft” damping force characteristic side, the control electric current is reduced, and the power consumption can be reduced.

Next, a damping force variable damper according to a fourth embodiment will be explained with reference to FIG. 8. It should be noted that, in the following explanation, portions similar to those in the above-described third embodiment are denoted by the same reference marks as in the third embodiment, and that only the portions in which the fourth embodiment differs from the third embodiment will be explained in detail.

A damping force variable damper 76 according to this embodiment omits the second port 20, the compression passage 23, the compression damping valve 26, the filter 33 and the fail-safe on-off valve 75. In the damping force variable damper 76, the downstream side of the extension passage 22 is connected to the reservoir port 21.

With the above-described structure, normally, the fail-safe on-off valve 31 is closed to cut off the fail-safe passage 24, and the fail-safe on-off valve 74 is opened to open the extension passage 22, in response to the control electric current from the controller 11. In this state, during the extension stroke of the piston rod 14, the check valve 17 is closed by the sliding movement of the piston 13, and thus the hydraulic oil in the cylinder chamber 12A is pressurized to flow into the reservoir 15 through the first port 19, the extension passage 22 and the reservoir port 21. Consequently, damping force is generated by the extension damping valve 25, and the damping force can be adjusted according to the control electric current. At this time, an amount of hydraulic oil corresponding to the amount by which the piston 13 moves flows into the cylinder chamber 12B from the reservoir 15 by opening the check valve 18. In addition, the gas In the reservoir 15 expands by an amount corresponding to the amount by which the piston rod 14 withdraws from the cylinder 12, thereby making volumetric compensation.

During the compression stroke of the piston rod 14, as the piston 13 slidingly moves, the check valve 17 opens, whereas the check valve 18 is closed. Consequently, an amount of hydraulic oil corresponding to the amount by which the piston rod 14 enters the cylinder 12 flows from the cylinder chamber 12A through the first port 19, the extension passage 22 and the reservoir port 21 into the reservoir 15, in the same way as during the extension stroke, causing the gas in the reservoir 15 to be compressed. Thus, damping force is generated by the extension damping valve 25, and the damping force can be adjusted according to the control electric current.

That is, the extension passage 22 serves as both the extension and compression flow paths. During both the extension and compression strokes, damping force is generated by the extension damping valve 25 comprising a disk valve, and the damping force can be adjusted according to the control electric current.

When a failure occurs, the supply of electric current to the fail-safe on-off valves 31 and 74 is cut off. Consequently, the fail-safe on-off valve 31 opens to open the flow path of the fail-safe passage 24, whereas the fail-safe on-off valve 74 is closed to cut off the flow path of the extension passage 22. In this state, during both the extension and compression strokes of the piston rod 14, hydraulic oil flows through the fail-safe passage 24, and a predetermined damping force is generated by the fail-safe valve 27 comprising a poppet valve.

It should be noted that, in all the embodiments, the present invention has been explained by way of an example in which the present invention is applied to a cylinder apparatus controlling vibrations in the right-and-left direction. The present invention, however, may also be applied to a cylinder apparatus controlling vibrations in the up-and-down direction.

The present invention can also be used in an inter-car damper.

The first damping force generating mechanism maybe of either the inverting or non-inverting type. If an inverting type damping force generating mechanism is used, it is possible to omit the stroke sensor 9 shown in FIG. 1. Even if a non-inverting type damping force generating mechanism is used, the stroke sensor 9 may be omitted according to the control contents.

### REFERENCE SIGNS LIST

6 . . . damping force variable damper (damper for railway vehicles), 12 . . . cylinder, 13 . . . piston, 14 . . . piston rod, 22 . . . extension, passage (first passage), 23 . . . compression passage (first passage), 24 . . . fail-safe passage (second passage), 25 . . . extension damping valve (first damping force generating mechanism), 26 . . . compression damping valve (first damping force generating mechanism), 27 . . . fail-safe valve (second damping force generating mechanism), 28 . . . fail-safe switching valve (switching device), 29 . . . fail-safe on-off valve (switching device).

1. A damper mounted to a railway vehicle, the damper comprising:
a cylinder having a hydraulic fluid sealed therein;
a piston slidably inserted in the cylinder;
a piston rod coupled to the piston;
a first and second passages through which the hydraulic fluid flows in response to movement of the piston;
a first damping force generating mechanism generating damping force by controlling flow of hydraulic fluid through the first passage;
a second damping force generating mechanism generating damping force by controlling flow of hydraulic fluid through the second passage; and
a switching device switching a flow path of hydraulic fluid between the first passage and the second passage in response to a control electric current such that, when energized, the switching device opens the first passage and closes the second passage, whereas, when not energized, the switching device closes or makes the first passage narrower than the second passage and opens the second passage;
wherein the first damping force generating mechanism includes a disk valve opening upon receiving a pressure of the hydraulic fluid, and the second damping force generating mechanism is of a poppet type.

2. The damper of claim 1, wherein the first damping force generating mechanism is capable of adjusting damping force according to a control electric current.

3. The damper of claim 1, wherein the first passage has an extension passage through which the hydraulic fluid flows during an extension stroke of the piston rod, and a compression passage through which the hydraulic fluid flows during a compression stroke of the piston rod, and the first damping force generating mechanism is provided for each of the extension passage and the compression passage.

4. The damper of claim 2, wherein the first passage has an extension passage through which the hydraulic fluid flows during an extension stroke of the piston rod, and a compression passage through which the hydraulic fluid flows during a compression stroke of the piston rod, and the first damping force generating mechanism is provided for each of the extension passage and the compression passage.
